(19) United States
(12) Patent Application Publication
(10) Pub. No.: US 2003/0066664 A1
(43) Pub. Date: Apr. 10, 2003

(54) Ripper assembly

(75) Inventor: James Allan Matthews, Moranbah (AU)

Correspondence Address: G. Peter Nichols, BRINKS HOFER, GILSON & LIONE, P.O. BOX 10395, CHICAGO, IL, 60610, US

(73) Assignee: BHP Innovation Pty. Ltd.

(21) Appl. No.: 10/232,527

(22) Filed: Aug. 29, 2002

Related U.S. Application Data
(63) Continuation of application No. PCT/AU01/00204, filed on Feb. 28, 2001.

(51) Int. Cl. A01B 13/08

(52) U.S. Cl. 172/699

(57) ABSTRACT

A ripper assembly having attachment shanks and a sliding pad through which the attachment shanks extend. The pad has an upwardly curved leading edge. each shank has a boot for receiving a ripper shank. Additional boots extend through the pad and have boots for receiving ripper shanks.

This is a continuation of PCT/AU01/00204 which designates the U.S. and which claims priority to PQ5920 filed in Australia on Feb. 29, 2000, the entire contents of both are incorporated herein by reference.

### FIELD OF THE INVENTION

The present invention relates generally to ripper assemblies of the type used by earth-moving machines and, in particular, to ripper assemblies used by bulldozers during earthworks.

Although the invention has been developed primarily for bulldozers having a weight of greater than 70 tonnes, it will be appreciated that the invention can be used with bulldozers or other earth-moving machines having a weight less than this.

It commonly happens that during earthworks, it is necessary for earthmoving machines to loosen the ground being worked upon so as to enable the earthmoving machinery to work the ground in the desired manner. The ground loosening is usually accomplished by a ripper assembly attached to a bulldozer. The ripper assembly usually consists of three separate ripper shanks. The ripper shanks attach to a multi-shank ripper box that is attached to the bulldozer. The ripper shanks are substantially perpendicular to the ground when they are attached to the ripper box.

When the ripper shanks are not in use, the ripper box is raised so that the ripper shanks are not in contact with the ground. When the ripper shanks are being used, the ripper box is lowered so that the ripper shanks penetrate into the ground. The amount of penetration depends upon how far the operator of the bulldozer lowers the ripper box. When lowered, the ripper shanks tear into and loosen the ground as the bulldozer moves forward.

During open-cut mining operations, it is necessary to create a flat surface upon which loaders and trucks can drive on. At present, graders and water trucks are used to create these roads. A problem with using graders is that they cannot penetrate sandstone or mudstone surfaces. Also, graders have a tendency to tear out slabs of rock. Thus, the road surface produced is usually less than satisfactory.

Although a conventional ripper assembly such as that previously described can be used in order to loosen sandstone or mudstone surfaces, a disadvantage of the prior art ripper assembly is that the surface it produces almost always includes large chunks of rock. Also, the ripper shanks do not always penetrate the ground to a consistent depth. In summary, the surface produced by a traditional ripper assembly is not consistent and is therefore not ideal for grading.

It is therefore an object of the present invention to provide an improved ripper assembly that substantially overcomes, or at least ameliorates, one or more of the deficiencies of the prior art.

### SUMMARY OF THE INVENTION

According to a first aspect of the present invention there is provided a ripper assembly for attachment to an earth-moving machine, the ripper assembly having an attachment portion for attaching the ripper assembly to the earth-moving machine; a plurality of ripper shanks attached to and at spaced locations along the ripper assembly, wherein the ripper shanks may engage with a work surface; and a sliding pad attached to the ripper assembly such that when the ripper shanks are engaged with the work surface a lower surface of the sliding pad extends across and may engage with the work surface.

Preferably, the attachment portion comprises one or more attachment shanks that can be attached to a ripper box of the earth-moving machine. Preferably, the sliding pad is attached to the attachment portion. The front portion of the sliding plate is upwardly directed. Preferably, the front portion is upwardly curved.

### BRIEF DESCRIPTION OF THE DRAWINGS

Embodiments of the present invention will now be described with reference to the drawings in which:

FIG. 1 is a diagram that illustrates a prior art ripper assembly attached to a bulldozer;

FIG. 2 is a diagram that illustrates the prior art ripper assembly of FIG. 1 with one ripper shank removed from the ripper box;

FIG. 3 is a close-up view of the removed ripper shank and ripper box shown in FIG. 2;

FIG. 4 is a perspective view of a ripper assembly according to a first embodiment of the present invention;

FIG. 5 is a front view of the ripper assembly of FIG. 4 attached to a ripper box;

FIG. 6 is an inverted plan view of the ripper assembly of one embodiment of the invention; and

FIG. 7 is an inverted plan view of the ripper assembly of another embodiment of the invention.

### DETAILED DESCRIPTION

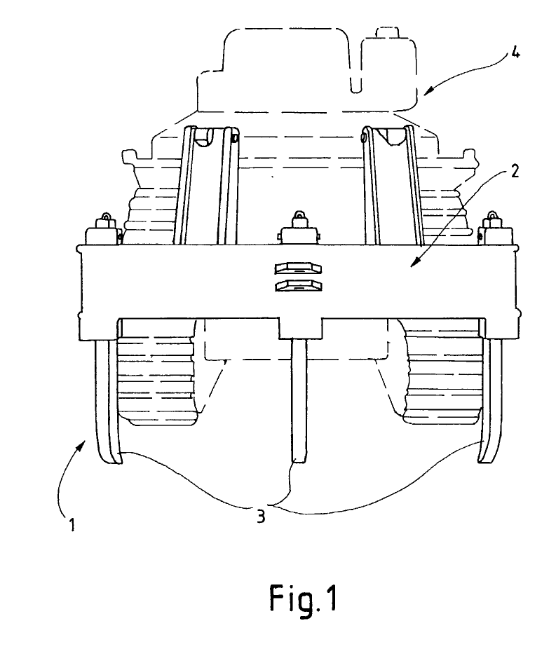

FIG. 1 illustrates a prior art ripper assembly 1 attached to a ripper box 2 of a bulldozer 4. The ripper assembly 1 comprises ripper shanks 3.

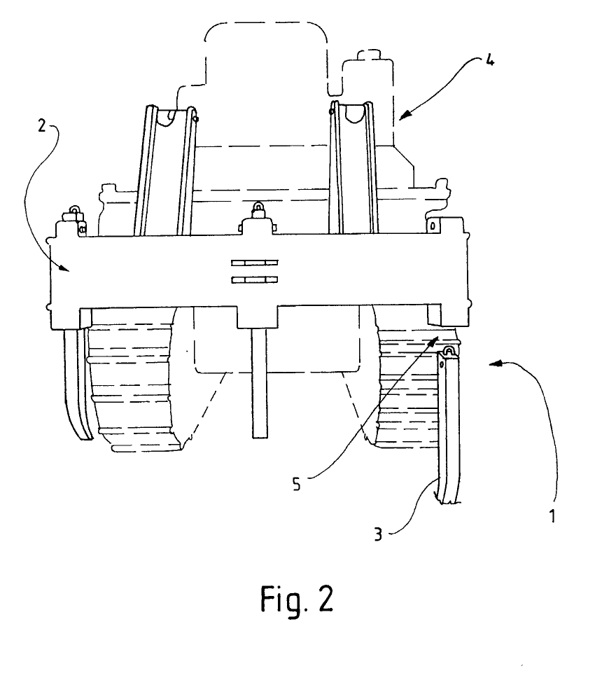

FIG. 2 illustrates a ripper assembly 1 attached to a bulldozer 4 with one of the ripper shanks 3 removed from the ripper box 2. In this case, the removed ripper shank 3 is embedded in the ground on which the bulldozer 4 rests. A ripper boot 5 is clearly shown in this diagram. The ripper boot 5, which forms part of the ripper box 2, holds the ripper shank 3 when the ripper shank 3 is attached to the ripper box 2.

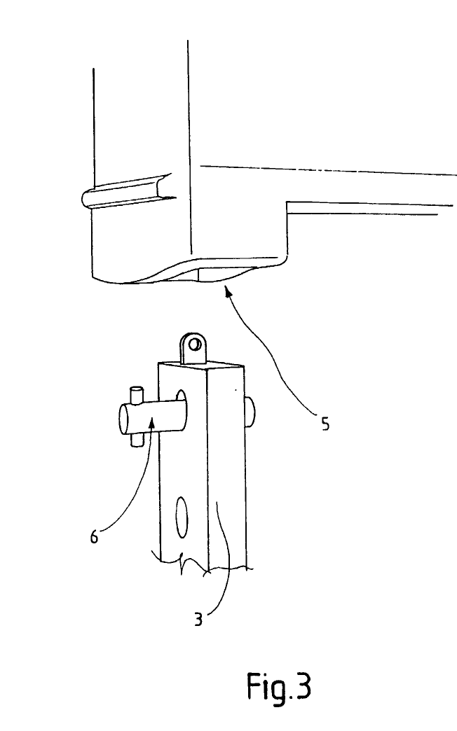

FIG. 3 illustrates a portion of the ripper box 2 and the removed ripper shank 3 illustrated in FIG. 2 from the opposite side of the ripper box 2. A ripper pin 6 that holds the ripper shank 3 in the ripper box 2 is clearly shown in this diagram. Also, the structure of the ripper boot 5, which is a square-shaped metal tube, can be clearly seen.

In order to operate the ripper assembly shown in FIGS. 1 to 3, an operator of the bulldozer 4 must lower the ripper box 2 so that the ripper shanks 3 penetrate into the ground. As the bulldozer 4 moves along, the ripper shanks 3 tear or rip into the ground.

Also, the depth of penetration of the shanks 3 can be altered by raising or lowering the ripper box 2.

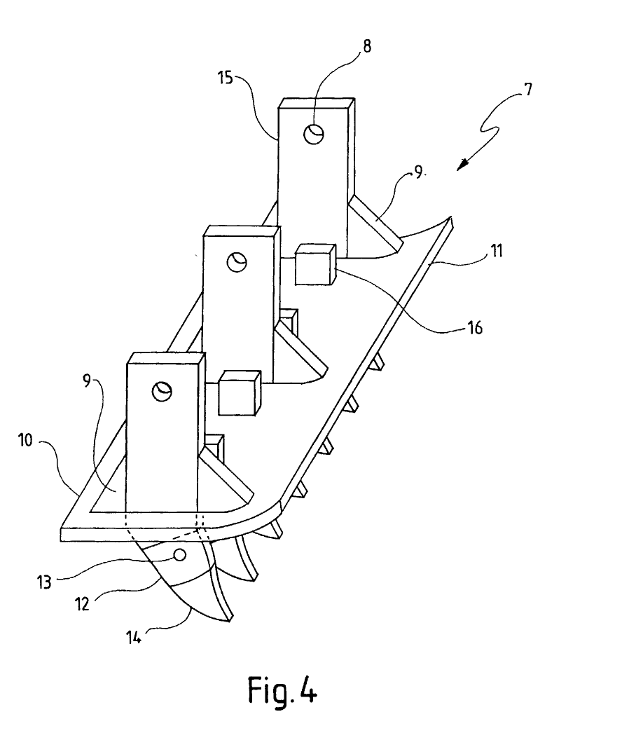

FIG. 4 illustrates a first embodiment of the ripper assembly 7. The ripper assembly 7 can be constructed of metal and can be attached to the ripper box 2 illustrated in FIGS. 1 to 3.

The ripper assembly 7 comprises attachment shanks 15 having holes 8. The shanks 15 can be inserted into ripper boot 5 of ripper box 2. The holes 8 in the shanks 15 allow the ripper assembly 7 to be fixed to the ripper box 2 by ripper shank pins 6.

A sliding pad 10 is attached to shanks 15 and the shanks 15 extend through the pad 10. Shank braces 9 provide further support between the sliding pad 10 and the shanks 15. The sliding pad 10 has an upwardly curved front portion 11. Extending from a bottom portion of the sliding pad 10 are seven shank boots 12. Each of these shank boots 12 is hollow and can accommodate a ripper shank 14. Further, each ripper boot 12 and each ripper shank 14 includes a hole 13. In order to attach the ripper shanks 14 to the ripper boots 12, a ripper shank pin like pin 6 is inserted into each hole 13. This enables the number of ripper shanks 14 to be varied and also enables worn-out ripper shanks 14 to be easily replaced.

The middle and outermost shank boots are attached to a lower portion of the attachment shanks 15. The remaining shank boots 16 are interposed between the attachment shanks 15 and also protrude through the sliding pad 10. In this embodiment, the length of the remaining shank boots 16 is half that of the shanks 15.

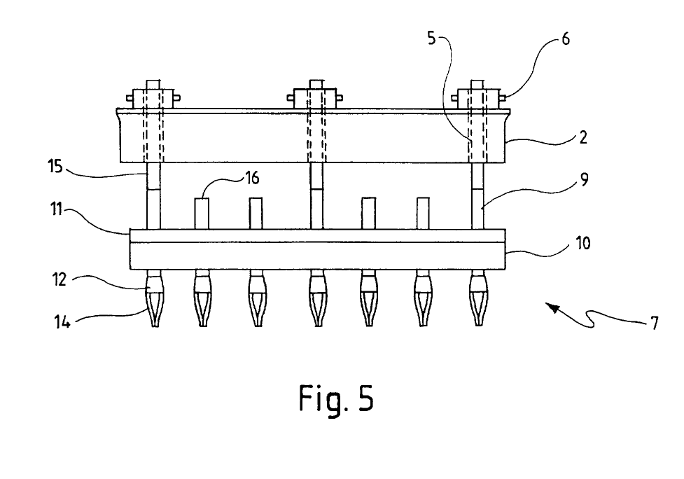

FIG. 5 is a front view of the ripper assembly 7 attached to a ripper assembly box 2 by ripper shank pins 6. Each of the ripper shanks 14 can be seen in this diagram.

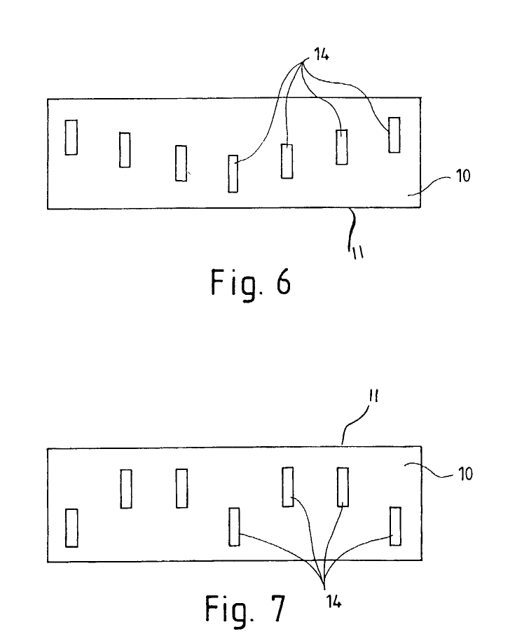

FIG. 6 is an inverted plan view of the assembly shown in FIGS. 4 and 5. In FIGS. 4 and 5 the ripper shanks are arranged at spaced locations along the sliding pad 10. The shanks 14 are located in a straight line along the pad 10. In FIG. 6 the shanks are still located at spaced locations along the pad 10 but in a V shaped pattern rather than in a straight line. In FIG. 7 the shanks 14 are arranged in a W shaped pattern.

The operation of the ripper assembly 7 will now be described with reference to FIGS. 4 and 5. Before the ripper assembly 7 can be used, it must be attached to the ripper box 2 of the bulldozer 4. In order to accomplish this, the operator of the bulldozer 4 lowers the ripper box 2 so that the ripper boots 5 align with the upwardly pointing attachment shanks 15 of the ripper assembly 7. Once the ripper boots 5 and the shanks 15 are aligned, the ripper box 2 can be lowered onto the shanks 15. When the shanks 15 are fully inserted into the ripper boots 5 of the ripper box 2, the ripper shank pins 6 can be inserted into the holes 8 of the shanks 15.

When attaching the ripper assembly 7 to the bulldozer 4, the curved portion 11 of the sliding pad 10 should face the rear of the bulldozer 4 in order for the ripper assembly 7 to operate correctly.

Once the ripper assembly 7 has been attached to the ripper box 2, the operator of the bulldozer 4 can then lower or raise the ripper assembly 7. Thus, when the operator of the bulldozer 4 wishes to commence using the ripper assembly 7, he or she merely lowers the ripper assembly 7 so that the ripper shanks 14 penetrate into the ground.

As the bulldozer 4 moves forward, the ripper shanks 14 rip the ground in a manner similar to the prior art ripper assembly. Although the ripper shanks 14 can bring slabs of rock to the surface, these are crushed by the sliding pad 10 and by the operator of the bulldozer 4 applying more downward pressure to the ripper assembly 7. The sliding pad is adapted to extend across at least 70% of the width of the work surface that is traversed in one pass of the earth moving machine as it progresses over the work surface. More preferably, the sliding pad is adapted to extend across the full width of the work surface.

The curved portion 11 of the sliding pad 10 prevents the sliding pad 10 from digging into the ground. Also, the curved portion 11 prevents the rocks from passing over the pad 10 and enables the ripper assembly 7 to crush large rocks.

The surface produced by the ripper assembly 7 as it moves over the ground is quite flat and evenly textured. This is because the ripper shanks 14 rip to a consistent depth and also because the sliding pad 10 crushes the larger rocks. The surface produced provides a much improved road base for a grader to work with. Also, the nature of the ripped surface allows water to penetrate into the loose material for better compaction.

1. A ripper assembly for attachment to an earth-moving machine, the ripper assembly having;
an attachment portion for attaching the ripper assembly to the earth-moving machine;
a plurality of ripper shanks attached to and at spaced locations along the ripper assembly, wherein the ripper shanks may engage with a work surface; and
a sliding pad attached to the ripper assembly such that when the ripper shanks are engaged with the work surface a lower surface of the sliding pad extends across and may engage with the work surface.

2. The ripper assembly of claim 1 wherein the attachment portion includes a plurality of attachment shanks attached to and extending through the sliding pad.

3. The ripper assembly of claim 2 wherein the attachment shanks terminate in shank boot for receiving a ripper shank.

4. The ripper assembly of claim 3 including further shank boots interposed between the attachment shanks and each said further shank boot receiving a respective said ripper shank, the further shank boots extending through the sliding pad and being attached thereto.

5. The ripper assembly of claim 3 wherein the shank boots are arranged at spaced locations along the sliding pad and in a V formation.

6. The ripper assembly of claim 3 wherein the shank boots are arranged at spaced locations along the sliding pad and in a W formation.

7. The ripper assembly of claim 1 wherein a leading edge of the sliding pad is upwardly directed relative to the remainder of the pad.

8. The ripper assembly of claim 7 wherein the leading edge of the pad is upwardly curved.

9. The ripper assembly of claim 1 wherein the sliding pad is adapted to extend across at least 70% of the width of the work surface that is traversed in one pass of the earth moving machine.

10. The ripper assembly of claim 9 wherein the sliding pad is adapted to extend across the full width of the work surface that is traversed in one pass of the earth moving machine.

11. The ripper assembly of claim 1 wherein the sliding pad is adapted to act as a contact surface with the work surface for crushing rocks that are lifted upwardly by movement of the ripper shanks through the work surface in use of the earth moving machine.
